(19) United States
(12) Patent Application Publication
(10) Pub. No.: US 2012/0200206 A1
(43) Pub. Date: Aug. 9, 2012

(54) SYSTEM AND METHOD FOR DESIGNING A CONFIGURABLE MODULAR DATA CENTER

(75) Inventors: Ty Schmitt, Round Rock, TX (US); Mark M. Bailey, Burnet, TX (US)

(73) Assignee: DELL PRODUCTS L.P.

(21) Appl. No.: 13/022,018

(22) Filed: Feb. 7, 2011

(51) Int. Cl. A47B 87/00; B23P 17/00

(52) U.S. Cl. 312/107; 29/592

(57) ABSTRACT

In accordance with the present disclosure, a system and method for designing a configurable modular data center is presented. A configurable modular data center designed according to this invention may include a plurality of modules. Each of the modules may be dedicated to one of the primary elements of a data center, such as fluid handling, computing and power. Each of the plurality of modules may be separately configurable, according, at least in part, to operational and environmental requirements for the modular data center. The plurality of modules may then be incorporated into at least one modular data center structure, whose size and shape will depend, at least in part, on the configuration of each of the plurality of modules.

### CROSS REFERENCES TO RELATED APPLICATIONS

This application is related to co-pending U.S. patent application Ser. No. ______ [Attorney Docket No. 061295.4240, DC-18499] entitled “System and Method for Concurrent Manufacturing, Testing, and Integration of a Modular Data Center” which was filed on ______, 2011, U.S. patent application Ser. No. ______[Attorney Docket No. 016295.4241, DC-18500] entitled “System and Method for a Modular Fluid Handling System with Modes in a Modular Data Center” which was also filed on ______, 2011, U.S. patent application Ser. No. ______[Attorney Docket No. 016295.4242, DC-18502] entitled “System and Method for Structural, Modular Power Distribution in a Modular Data Center”, which was also filed on ______, 2011, U.S. patent application Ser. No. ______[Attorney Docket No. 016295.4243, DC-18503] entitled “System and Method for an Optimizable Rack Solution”, which was also filed on ______, 2011, all of which are incorporated herein by reference for all purposes.

### TECHNICAL FIELD

The present disclosure relates generally to the operation of computer systems and information handling systems, and, more particularly, to a system and method for designing a configurable modular data center.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

A group of information handling systems may be included in a data center. In a containerized data center, the information handling systems are included in racks that are installed within the enclosure of a shipping container sized according to standards set by the International Organization for Standardization (“ISO”). ISO shipping containers are generally 20 feet long by 8 feet wide, or 40 feet long by 8 feet wide. Utilizing ISO shipping containers is advantageous because they are easily available and provide for cost-efficient shipping of a completed containerized data center. One problem with building containerized data centers in ISO shipping containers, however, is that the footprint of the data center is set, restricting its design possibilities and utility in places that cannot accommodate the standard sizes of an ISO shipping container. For example, if a location has thirty feet of available space, one is limited to either adopting a containerized data center that utilizes less that full thirty feet (such as the 20-foot long shipping container) or foregoing a containerized data center entirely if a 20-foot shipping container cannot include enough computational power to accomplish necessary tasks.

Additionally, current containerized data centers generally provide limited design alternatives and cannot be configured according a wide variety of specific operational and environmental design limitations. Due to the space limitations imposed by the ISO shipping container, much of the design of a containerized data center is directed to situating each of the primary data center elements into the ISO container in a functional manner. Although there is some variability in the design of the data center elements, this variability is limited by the space within the ISO shipping container and the need for each of the design element to be integrated within shipping container. In other words, the range of requirements to which the existing containerized data centers can be configured is narrow, as the design of the overall data center and each of the data center components is limited by the space limitations of the ISO shipping container. Likewise, modifying any of the data center elements, or adding additional equipment, is difficult and costly, as the containerized data center may have to be redesigned to accommodate the changes.

### SUMMARY

In accordance with the present disclosure, a system and method for designing a configurable modular data center is presented. A configurable modular data center designed according to this invention may include a plurality of modules. Each of the modules may be dedicated to one of the primary elements of a data center, such as fluid handling, computing and power. Each of the plurality of modules may be separately configurable, according, at least in part, to operational and environmental requirements for the modular data center. The plurality of modules may then be incorporated into at least one modular data center structure, whose size and shape will depend, at least in part, on the configuration of each of the plurality of modules.

The system and method disclosed herein is technically advantageous because it allows for a much wider range of design alternatives to be incorporated into a modular data center. One advantage is in escaping the design constraints of an existing containerized data center integrated into an ISO shipping container. Breaking design elements into separately configurable modules generally removes the space limitations of an existing containerized data center. With the space limitations generally removed, each of the modules can be designed according to a specific design purpose, and can take a widely varying number of configurations to accomplish the purpose of the module. An additional advantage is the ability to modify the footprint of the modular data center, including the length and width of the modular data center according to the space limitations of the deployment location. Existing modular data centers have a fixed footprint and require a fixed amount of space to be deployed. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is block illustration of a modular data center according to one embodiment of the present invention.

FIG. 2 is a power module according to one embodiment of the present invention.

FIG. 3 is an IT module according to one embodiment of the present invention.

FIG. 4 is a modular data center incorporating one embodiment of a fluid handling module according to the present invention.

FIG. 5 is a diagram of a method for designing a configurable modular data center according to one embodiment of the present invention.

FIG. 6 is a configurable modular data center according to one embodiment of the present invention.

FIG. 7 is a configurable modular data center according to another embodiment of the present invention.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

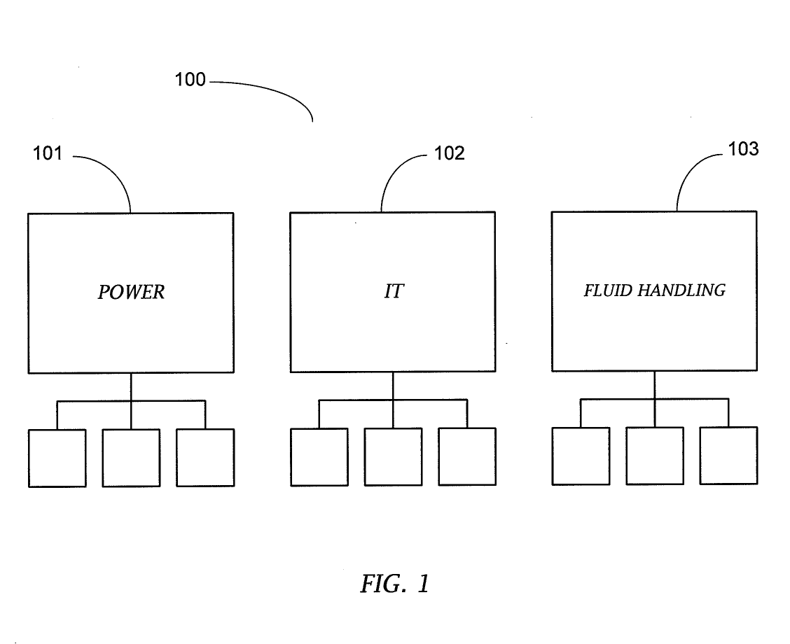

FIG. 1 shows a block illustration of a modular data center 100 with a plurality of modules: power module 101, IT module 102, and fluid handling module 103 according to one embodiment of the present invention. The modular data center 100 may be a type of movable data center, meaning it is shipped to a remote deployment location for use. A modular data center may further incorporate a plurality of modules per this disclosure and be partially or entirely built or assembled at one location and moved or shipped to a deployment location where it is to be used. Each of the power module 101, the IT module 102, and the fluid handling module 103, as will be discussed below, may be purpose-built and may be assembled, as building blocks, to form a modular data center that is similarly purpose-built. Depending on the operational requirements of the data center, some of the building blocks may not be required.

Each of the modules may be comprised of smaller modules, as can be seen in FIG. 1. The smaller modules may similarly be individually designed and assembled to create the larger module. Additionally, each of the power module 101, the IT module 102, and the fluid handling module 103 may be dedicated to and include all of the equipment for the corresponding primary element. The fluid handling module 103, for example, may include all or most of the cooling equipment—e.g. fans, artificial cooling mechanisms, etc.—for the modular data center 100. The IT module 102 may include all of the information handling systems for the modular data center as well as the racks to hold the information handling systems and the power distribution elements to provide power to each of the information handling system. The power module 101 may include all or most of the power elements necessary to provide power to the IT module 102 and fluid handling module 103, such as batteries, etc. The equipment listed above is not intended to be an exhaustive list, and each of the modules listed above may include other equipment that is well known in the art to be part of a fluid handling system, a power system, and an IT system. Likewise, the plurality of modules may include modules dedicated to other elements or may be dedicated to sub-divided portions of the primary elements.

The IT module 102, power module 101, and fluid handling module 103 may be combined in a variety of configurations, each configuration dependant upon the operational requirement of the modular data center. For example, the fluid handling module 103 may include an air mover attached to the top the of an IT module 102. The fluid handling module 103 may also include elements attached to the bottom or sides of the IT module 102, or even free standing elements connected to the IT module through pipes. Likewise, the power module 101 may be deployed in a separate structural enclosure from the IT module 102 and fluid handling module 103, and may be attached to the IT module 102 and fluid handling module 103 via a plurality of power cables known in the art. Each of the fluid handling module 103 and the power module 101 may also be optional, depending on the conditions of the deployment location for the modular data center. A modular data center which can take a variety of shapes and sizes is advantageous because it allows for a wide variety of design alternatives in a wide variety of footprints, as opposed to an existing containerized data center which is constrained by the enclosure and footprint of a standard ISO shipping container.

Each of the modules 101, 102, and 103 may be separately configurable, meaning that each module may be designed and configured as its own insular system, according to the overall operational and environmental requirements of the system or a subset of the operational and environmental requirements of the system that subsystem. The operational and environmental requirements of the modular data center may include, for example, the space available to deploy the data center, the power available at the location, the amount of computing power required, local building and power code requirements, the climatic conditions of the location where the data center is to be deployed, and the type of information handling system to be utilized in the data center. Separately configuring each of a plurality of modules may also include selecting between one of a plurality of pre-designed configurations for each module according to the operational and environmental requirements. Each of the pre-designed configurations may include a plurality of sub-modules designed for or which correspond to each module, and that can each be configured according to the design needs of the corresponding module.

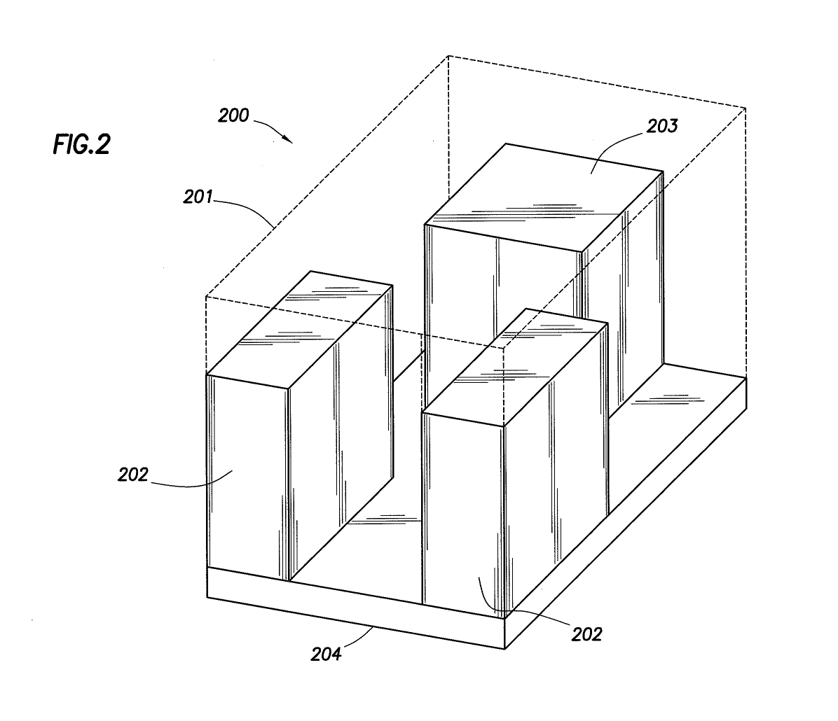

FIG. 2 shows a separately configurable power module 200 according to one aspect of the present invention. The present embodiment includes an outer structure 201 which is shown as transparent in FIG. 2 to facilitate a view of the interior components of the power module 200. The components of the power module 200 may include multiple arrays of batteries 202 and an uninterruptible power supply 203, each resting on base 204. All of the structure 201 and the components within the power module 200 may be designed, configured, and combined as part of the separate configuration of the power module 200. For example, the power module 200 may need to provide redundant output power with failover support, and, as such, may include duplicate uninterruptable power supplies, batteries, flywheels, etc. In other example, the power module 200 may not be necessary at all, particularly when a deployment location has a conditioned power supply that can be plugged directly into an IT module. Likewise, the size of the power module 200 can be modified according to the power equipment that needs to be included within the power module 200, providing a large number of possible configurations and output power levels. Advantageously, approaching the power module 200 as insular, and separately configuring the power module 200 in the manner described above, allows for a large number of possible configurations which are generally not limited by the design and placement of the other data center elements, as is the case in an existing containerized data center.

In one embodiment, separately configuring the power module 200 may include choosing between one of a plurality of pre-designed power sub-modules. The pre-designed sub-modules may include specific configurations of batteries, flywheels, uninterruptable power supplies, cables, etc. This is advantageous in that selecting between pre-designed sub-modules decreases the design time for the entire data center. For example, the pre-designed sub-modules may be designed to be easily interchangeable within the larger corresponding module. This is advantageous if, for example, the output power requirements changes during the manufacturing process, as is common. In those instances, a pre-designed sub-module, such as array of batteries 202, may be interchanged with another sub-module, such as a different array of batteries 202 to provide the new output power, without having to redesign the entire power module 200.

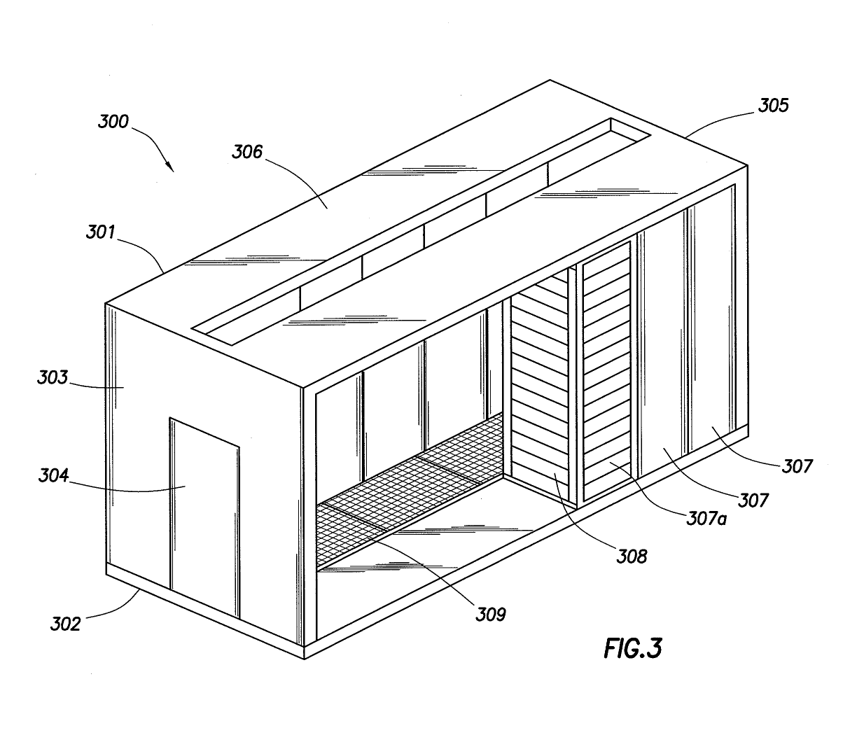

FIG. 3 is a separately configurable IT module 300 according to one embodiment of the present invention. The IT module 300 may include a structure 301 with a base 302, a front 303 that includes a door 304 for access to the interior of the IT module 300, a back 305, and a top 306. Notably, as is shown in FIG. 3, one or both sides of the IT module 300 may be open, allowing external access to racks 307. The components of the IT module 300 may include the racks 307, information handling systems 308, and power distribution equipment. In the embodiment shown in FIG. 3, the racks 307 form two rows around a center aisle 309. In other embodiments, the racks may take a variety of configurations, including a single, off-set row. All of the structure 301 and components of the IT module 300 may be designed, configured, and combined as part of separately configuring the IT module 300 according to the operational and environmental requirements of the modular data center. For example, the IT module may need to include a certain number of information handling systems for the modular data center to meet the computing requirements for the modular data center. The IT module 300 may be separately configured according to the computing requirement, including selecting the size of the structure 301 necessary to accommodate the required number of information handling systems, selecting the type and location of racks 306 within the IT module, and configuring the power distribution equipment within the IT module 208 according to location and placement of the racks.

The separately configurable nature of the IT module 300 is advantageous because it allows the IT module 300 to take a wide range of configurations not limited by the power or fluid handling availability. For example, because the power module 200 can be configured to provide numerous output power signatures, the IT module 300 is not limited to a particular input power. Likewise, as will be discussed below, because the fluid handling equipment may be in a separate module the IT module 300 may be designed without specifically accounting for the location of fluid handling equipment.

Configuring the IT module 301 may include selecting between a plurality of pre-designed sub-modules for the IT module 301, such as a structure 301, the racks 306 and power distribution elements. Some or all of the sub-modules for the IT module may be individually configured and designed for certain IT module configurations and may provide for interchangeable connections with other modular elements, such as a fluid handling module or other pre-designed sub-modules of the IT module 301. One example of a pre-designed sub-module of the IT module 301 may be a optimizable rack solution as described in the cross-referenced application entitled “System and Method for an Optimizable Rack Solution.” Each of the racks 306 may include be one of the optimizable racks described in the related application.

Another example of a pre-designed sub-module of the IT module 301 may be the modular power distribution system described in the cross-referenced application entitled “System and Method for Structural, Modular Power Distribution in a Modular Data Center.” The modular data system described in the related application incorporates all of the power distribution elements necessary to provide power to the information handling systems within the IT module 301. Additionally, the modular power distribution system may include interchangeable connections that can be scaled according to the location and number of the racks and information handling systems.

Yet another example of a pre-designed sub-module of the IT module 301 may be the structure 301. As can be seen, the structure 301 is designed and configured for the dual rack row configuration mentioned earlier. Additionally, the structure 301 includes aperture 310, disposed in the top 306 of structure 301. The aperture 310 may be included in a pre-designed structure of an IT module to provide a connection point with a fluid handling module, the connection point providing fluid communication between the IT module 301 and one embodiment of a pre-designed fluid handling module, as will be discussed below. Providing pre-designed connection points such as the aperture 310 is advantageous because it aide the interchangeability of modules, such as between the IT module 301 and a fluid handling module.

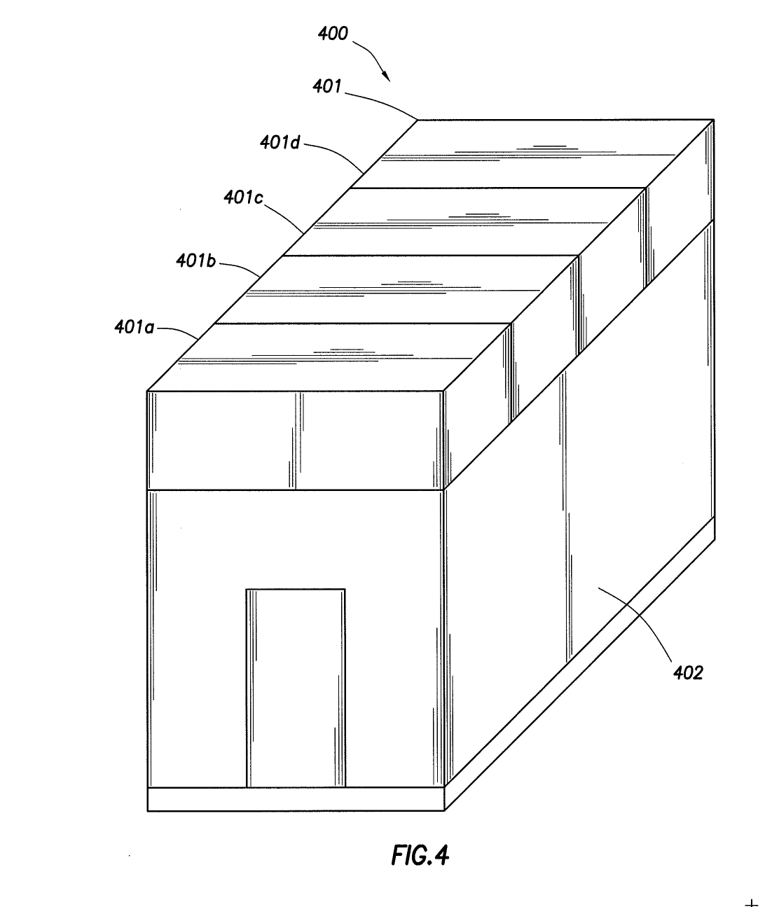

FIG. 4 is a modular data center 400 that incorporates one embodiment of the fluid handling module 401. The fluid handling module 401 may include a plurality of structural enclosures, sized similarly as and mounted to the IT module 402. Although the fluid handling module 401 is shown the same size as and mounted above the IT module 402, the fluid handling module 402 may take many size and shapes. The fluid handling module 402 may also include a plurality of components, such as fans, vents, and artificial cooling mechanisms. All of the structures 401a-d and the components within the structure 401a-d may be designed, configured, and combined as part of the separate configuration of the fluid handling module 400. For example, the fluid handling module 400 may be separately configured according to the external environmental conditions, such as varying temperature and humidity, of the deployment location. Because most or all of the cooling equipment may be located in fluid handling module 400, the fluid handling module 400 may be separately configured according to the environmental conditions and not, for example, the amount of cooling equipment that can be included in a container with information handling systems, as would be the case in an existing containerized data center. Rather, the fluid handling module 400 can take a wide variety of configurations provided there is fluid communication between the IT module 402 and the fluid handling module 401. Similarly, because a power module can be designed to provide a wide range of output power, one is generally not limited by available power when designing the fluid handling module 401.

The fluid handling module 400 may include take a plurality of configurations, each designed according to the most common environmental conditions in which the modular data center is to be deployed. The configurations may include numerous pre-designed sub-modules for the fluid handling module 400, according to the modular Fluid Handling system described in the cross-referenced application entitled “System and Method for Modular Fluid Handling Systems with Modes in a Modular Data Center.” The pre-designed sub-modules may include, for example, air handler, fans, dampers, radiators, chilled water pipes, etc. In one embodiment, as is shown in FIG. 4, the fluid handling module 400 may be divided into a plurality of similarly sized sub-modules 401a-d, or air handling units, which may include identical designs, and which may include connection points which correspond to an aperture on IT module 402, such as the aperture in FIG. 3. Pre-designed configurations of the fluid handling module 400 may include, for example, different numbers of air handling units depending on the length of the IT module 400. Additionally, pre-designed configurations of the fluid handling module 401 may include a plurality of other pre-designed sub-modules of various sizes and shapes as further described in the aforementioned application.

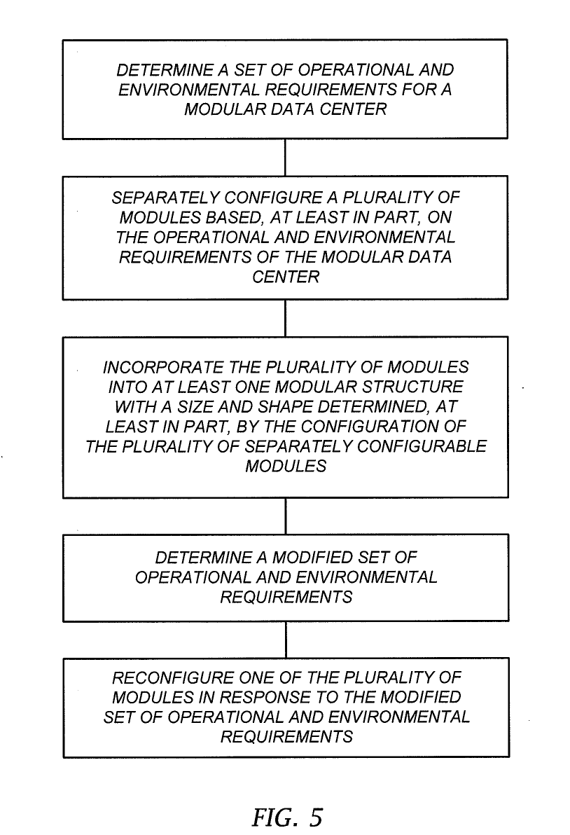

FIG. 5 is a flowchart for a method of designing and manufacturing a modular data center according to one embodiment of the present invention. The method includes a step of determining a set of environmental and operational requirements for a modular data center. As previously mentioned, the operational and environmental requirements may include any requirements relating to the location in which the modular data center will be deployed and the operational needs of the modular data center itself, including the space available to deploy the data center, the power available at the location, the amount of computing power required, local building and power code requirements, the climatic conditions of the location where the data center is to be deployed, and the type of information handling system to be utilized in the data center. Determining a set of environmental and operational requirements may define the design parameters for the modular data center.

The method also includes separately configuring a plurality of modules based, at least in part, on the operational and environmental requirements of the modular data center. Each module may correspond to a different design element. In one embodiment, each module corresponds to a primary design element: power, fluid handling, and IT. In some embodiments, however, there may not be modules for each primary design elements. For example, in instances where the power at the deployment location is sufficient, it may not be necessary to include a separate power module.

Separately configuring each of the plurality of modules may include designing and configuring each of the plurality of modules as an insular module, meaning each of the plurality of modules may take a variety of configurations that is not generally limited by the available configurations of the other modules. Separately configuring each of a plurality of modules may also include selecting a plurality of sub-modules designed for or which correspond to each module, and that can each be configured according to the design needs of the corresponding module.

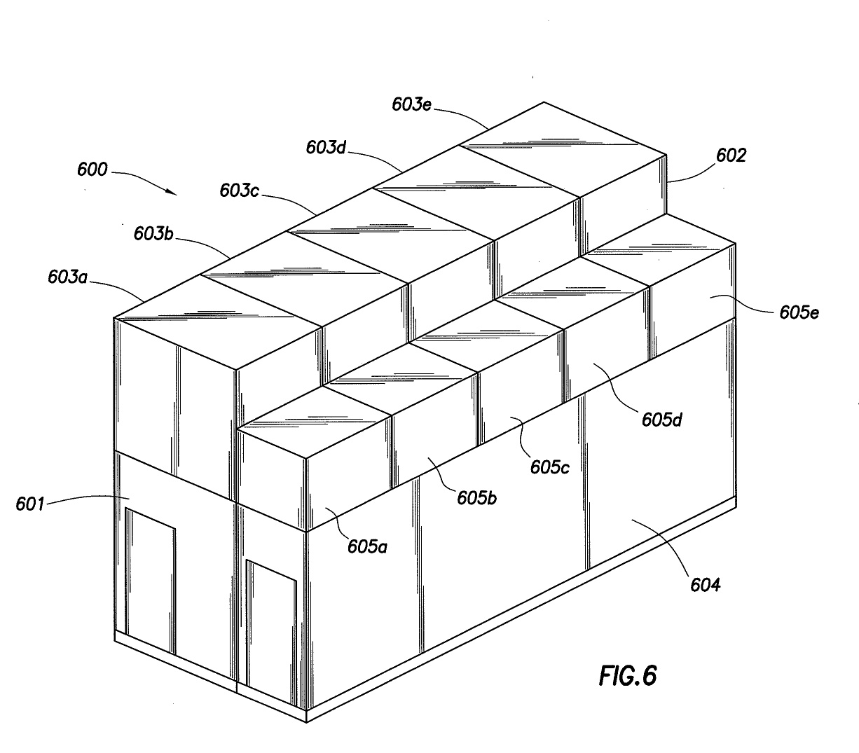

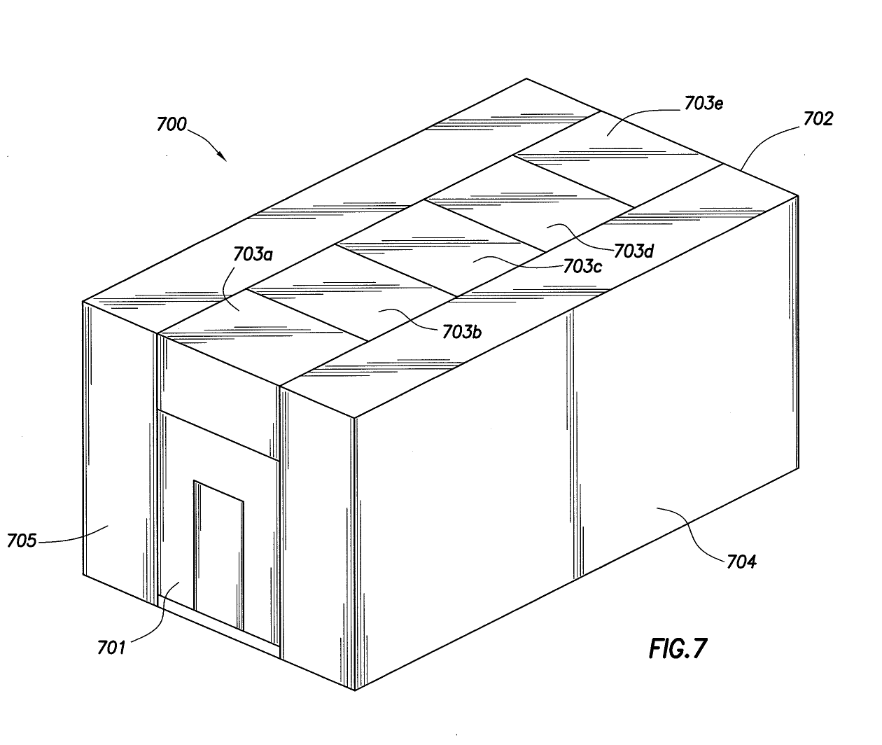

The method also includes incorporating the plurality of modules into at least one modular structure with a size and shape determined, at least in part, by the configuration of the plurality of separately configurable modules. As previously mentioned, the sizes of the plurality of modules can be altered according to the operational and environmental requirements for the design elements that correspond to each of the plurality of modules. Example of the differing shapes and sizes of a modular data center according to the present invention can be seen in FIG. 6. FIG. 6 is of a modular data center 600 with a IT module 601 and a fluid handling module 602 which incorporates one configuration of a plurality of sub-modules. The fluid handling module 602 includes a plurality of sub-modules 603a-e mounted on top of IT module 601. The combined footprint of the plurality of sub-modules 603a-e are generally the same as the footprint of IT module 601. The fluid handling module 602 also includes a sub-module 604 mounted to one side of the IT module 601, and an additional array of sub-modules 605a-e mounted on top of the sub-module 604. The size and shape of the arrangement found in FIG. 6 is clearly distinct from that found in FIG. 3, which did not include additional sub-modules mounted to one side of the IT module 602. Likewise, both of the modular data centers shown in FIG. 3 and FIG. 6 differ from modular data center 700, shown in FIG. 7. Modular data center 700 includes an IT module 701 and a fluid handling module 702 with sub-modules 703a-e, and 704 and 705, which are mounted on either side of IT module 701. As can clearly be seen, the width of the modular data center varies between modular data center 300, 600, and 700. Also, as mentioned above, the length and width of the IT module can be varied according to the space requirements for the modular data center and the information handling system capacity required.

Other embodiments may incorporate supplemental modules that are coupled to the IT, power, and Fluid Handling modules, but which are not components of any of the IT, power, and Fluid Handling modules. In such embodiments, the supplemental modules may comprise individual structural enclosures added to augment the function of or provide an additional function to one of the IT, the power, or the Fluid Handling modules. For example, in FIG. 7, elements 704 and 705 may not be a component of either IT module 701 or Fluid Handling module 702. Rather, elements 704 and 705 may be examples of supplemental modules which are coupled to both the IT module 701 and the Fluid Handling module 702 to provide one or more of fluid containment, fluid management, security, monitoring, access, environmental protection, lighting, power distribution access, etc. Similarly, elements 604 and 605a-e of FIG. 6, may be seen as individual structural elements installed to provide primary function to or extend the function of one of the IT, power, or Fluid Handling modules. These supplemental modules may aide one of the IT, Fluid Handling, or Power modules in one of its functions, such as fluid containment for the Fluid Handling module, or provide additional function to one of the IT, Fluid Handling, or Power modules, such as security or monitoring. Other shapes and sizes of supplemental modules are possible, as one of ordinary skill in the art in view of this disclosure would appreciate.

Returning to FIG. 5, the method may also include determining a modified set of operational and environmental limitations and reconfiguring one of the plurality of modules in response to the modified set of operational and environmental limitations. The operational and environmental limitations may change for a variety of reasons, such as the modular data center needing more computing power that it did before, or the modular data center being deployed in a different location that originally planned. These changes may severely delay the deployment of an existing containerized data center, because it may require the redesign of the placement and type of equipment in the shipping container. The present invention is advantageous, however, because a change in operational requirements may require reconfiguring only a single module in the system, which can be configured separately from the other modules. Also, the use of sub-modules may make alterations even more streamlined, reducing the delay in deployment from a altered operational or environmental limitation.

Although the present disclosure has been described in detail, it should be understood that various changes, substitutions, and alterations can be made hereto without departing from the spirit and the scope of the invention as defined by the appended claims.

What is claimed is:

1. A modular data center, comprising:
at least one configurable module, wherein the at least one configurable module is configured according to operational and environmental requirements of the modular data center;
at least one modular structure incorporating the at least one configurable module, wherein a size and shape of the at least one modular structure depends, at least in part, on the configuration of the at least one configurable module.

2. The modular data center on claim 1, wherein the at least one configurable module includes a fluid handling module, an IT module, and a power module.

3. The modular data center of claim 2, wherein each of the fluid handling module, the IT module, and the power module is dedicated to a different design element of the modular data center.

4. The modular data center of claim 3, wherein each of the fluid handling module, the IT module, and the power module is separately configurable.

5. The modular data center of claim 3, wherein each of the fluid handling module, power module, and IT module are separate structural frames.

6. The modular data center of claim 1, wherein the at least one configurable module includes an IT module, and wherein the IT module includes a structural frame with at least one open side.

7. The modular data center of claim 2, wherein each of the fluid handling module, the IT module, and the power module is comprised of a plurality of pre-designed, interchangeable sub-modules.

8. The modular data center of claim 1, wherein the at least one configurable module includes an IT module and only one of a fluid handling module and a power module.

9. The modular data center of claim 1, wherein the size, shape, and performance of the modular data center is alterable according to modified operational and environmental requirements.

10. A method for designing and manufacturing a modular data center, comprising:
determining operational and environmental requirements for a modular data center;
separately configuring each of a plurality of modules based, at least in part, on the operational and environmental requirements of the modular data center; and
incorporating the plurality of modules into at least one movable structure, wherein a size and shape of the at least one movable structure depends, at least in part, on the configuration of the plurality of individually configurable modules.

11. The method for designing and manufacturing a modular data center of claim 10, wherein each of the plurality of modules is dedicated to a different design element of the modular data center.

12. The method for designing and manufacturing a modular data center of claim 11, wherein the plurality of modules includes a fluid handling module, an IT module, and a power module.

13. The method for designing and manufacturing a modular data center of claim 11, wherein separately configuring each of the plurality of modules includes selecting between one of a plurality of pre-designed configurations that correspond to each of the plurality of modules.

14. The method for designing and manufacturing a modular data center of claim 12, wherein each of the fluid handling module, power module, and IT module are separate structural frames.

15. The method for designing and manufacturing a modular data center of claim 11, wherein separately configuring each of the plurality of modules includes selecting as a componenet at least one sub-module for each of the plurality of modules.

16. The method for designing and manufacturing a modular data center of claim 15, incorporating the plurality of modules into at least one movable structure includes selecting at least one supplemental module, wherein the supplemental module provides one at least one of access, security, and environmental protection.

17. The method for designing and manufacturing a modular data center of claim 10, wherein the plurality of modules includes an IT module and only one of a fluid handling module and a power module.

18. The method for designing and manufacturing a modular data center of claim 10, wherein the size, shape, and performance of the modular data center is alterable according to modified operational and environmental requirements.

19. A method for designing and manufacturing a modular data center, comprising:
determining operational and environmental requirements for a modular data center;
individually configuring a plurality of modules based, at least in part, on the operational and environmental requirements of the modular data center;
determining revised operational and environmental requirements;
reconfiguring at least one of the plurality of modules based, at least in part, on the revised operational and environmental requirements; and
incorporating the plurality of modules into at least one movable structure, wherein a size and shape of the at least one movable structure depends, at least in part, on the configuration of the plurality of individually configurable modules.

20. The modular data center of claim 20, wherein the plurality of modules includes a fluid handling module, an IT module, and a power module.
